(19) United States
(12) Patent Application Publication
(10) Pub. No.: US 2025/0254436 A1
(43) Pub. Date: Aug. 7, 2025

(54) MULTIMODAL ANTI-DRONE SYSTEM

(71) Applicant: OBSIDIAN SENSORS, INC., San Diego, CA (US)

(72) Inventors: John Hong, San Diego, CA (US); Bing Wen, San Diego, CA (US); Edward Chan, San Diego, CA (US); Tallis Chang, San Diego, CA (US)

(21) Appl. No.: 19/047,349

(22) Filed: Feb. 6, 2025

Related U.S. Application Data
(60) Provisional application No. 63/550,474, filed on Feb. 6, 2024.

(30) Foreign Application Priority Data
Feb. 6, 2025 (WO) PCT/US25/14761

(51) Int. Cl. H04N 23/90; F41H 11/02; F41H 13/00; G01J 5/00; G01J 5/08; G01J 5/20; H04N 23/23

(52) U.S. Cl. CPC H04N 23/90; F41H 11/02; F41H 13/0062; G01J 5/0859; G01J 5/20; H04N 23/23; G01J 2005/0077

(57) ABSTRACT

A system including: a plurality of arrayed thermal cameras to provide simultaneous viewing across a half hemisphere of field of regard, wherein each of the plurality of arrayed thermal cameras includes a camera field of view that is overlapping with neighboring cameras, and wherein outputs of the plurality of arrayed thermal cameras are electronically combined to provide a full coverage over the half hemisphere of field of regard.

### CROSS-REFERENCE TO RELATED APPLICATIONS

This application claims benefit of U.S. Provisional Application No. 63/550,474 filed Feb. 6, 2024 (entitled “Multimodal Anti-Drone System”). The disclosure of the above-referenced application is incorporated herein by reference.

### BACKGROUND

### Field

The present disclosure relates to an array of thermal cameras, and more specifically, to a multimodal anti-drone system including an array of thermal cameras.

### Background

In both commercial and defense sectors, unmanned aircraft systems (UAS) that wander into a protected area whether intentionally or by accident is a serious problem that enterprises must contend with. Intentional attacks especially by coordinated fleets of UAS are difficult to track and defeat and is quite asymmetric in terms of the high cost incurred to counter these extremely low-cost attack platforms. A common problem scenario is the protection of a given area of ground bounded by a fence-line of x Km diameter, where x may be in the range of 500 to 5000 m depending on the application. Since the attack can be coordinated from any direction, the detection and tracking must cover a hemisphere field of regard. As the UAS vehicles can fly up to 100 mph, even the most agile, mechanical turret is inadequate to cover the hemisphere. Moreover, coordinated flying of multiple drones, especially converging from opposite directions is especially problematic for gimbal mounted systems that must be steered to cover the field of regard. Traveling at 100 mph, a drone requires less than 25 seconds to traverse a detection range of 1 km. Multiple drones converging simultaneously will severely stress the mechanically steered tracking system.

Additionally, the subsystem that is designed to destroy or disable the offending drones must project sufficient power to at least disable the drones from carrying out their objectives whether they are approaching for a reconnaissance objective or delivering munitions with rapidity and agility to address rapidly moving targets. Because of the high cost and latency (of response) and potential for unintended damage both in and outside of the protected area, kinetic weapons are less desirable.

### SUMMARY

The present disclosure discloses a multimodal anti-drone system including an array of thermal cameras.

In one implementation, a system includes: a plurality of arrayed thermal cameras to provide simultaneous viewing across a half hemisphere of field of regard, wherein the plurality of arrayed thermal cameras includes a camera field of view that is overlapping with neighboring cameras.

In one implementation, the term “half hemisphere” refers to 2π steradians field of regard or substantial subset thereof. In other implementations, the field of regard may cover an entire 4π steradians field of regard (“a sphere”) or a substantial subset thereof.

In another implementation, a drone defeat system to disable a drone is disclosed. The drone defeat system includes: a plurality of steerable laser sources to impair or damage communication systems and sensors which are disposed at a focal plane of cameras on the drone; a laser combiner to combine outputs of the plurality of steerable laser sources into a combined output, wherein the combined output is directed toward the drone.]

In another implementation, a system of thermal cameras is disclosed. The thermal camera system includes: a set of thermal cameras each assigned to cover a certain field of view; a mechanical truss to hold the thermal cameras in alignment to tesselate the field of regard; and an edge AI processor integrated into each thermal camera.

In another implementation, a drone defeat system which works with the thermal camera system to impair the sensors and communication systems of a target drone is disclosed. The drone defeat system includes: a laser system that projects power in the visible-NIR spectrum (400-1000 nm) and LWIR spectrum (8-14 μm) to impair the dominant sensors used to guide drones autonomously and a microwave power projection system to impair drone communication electronics.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is an example illustration of a multimodal anti-drone system where the protected area geometry shown covers a circle of diameter D;

FIG. 2 illustrates an example half hemisphere tessellation in accordance with one implementation of the present disclosure with a scaled image of a sphere (e.g., the size of a soccer ball) inside to provide a scale reference;

FIG. 3 illustrates the comparative plot in accordance with one implementation of the present disclosure;

FIG. 4 illustrates an example deployable electronically steerable microwave power projection system in accordance with one implementation of the present disclosure;

FIG. 5A shows an example realization for a steerable reflector array in accordance with one implementation of the present disclosure;

FIGS. 5B and 5C illustrate an individual antenna element configuration, where the two antenna elements are coupled through a phase modulator;

FIG. 6A shows varactors used to modulate the microwave signal with a desired phase shift that is monotonically varying with the bias voltage across the variable capacitance diodes C1 and C2 (transmissive phase modulator configuration);

FIG. 6B shows an alternative implementation using reflective geometries with hybrid couplers to provide low-cost phase shifting at the single frequency operation of the system;

FIG. 7A illustrates a laser combiner in accordance with one implementation of the present disclosure;

FIG. 7B illustrates a laser combiner in accordance with another implementation of the present disclosure;

FIG. 7C illustrates a laser combiner in accordance with yet another implementation of the present disclosure; and

FIG. 8 shows an example two-mirror telescope to deliver the composite beam.

### DETAILED DESCRIPTION

As described above, because of the high cost and latency (of response) and potential for unintended damage both in and outside of the protected area, conventional kinetic weapons are less desirable for defending the protected area.

Certain implementations of the present disclosure provide for a multimodal anti-drone system including an array of thermal cameras. In one implementation, the anti-drone system includes multiple arrayed thermal cameras to provide simultaneous viewing across a half hemisphere of field coverage (or field of regard) with sufficient power to disable drones. In some implementations, the multiple arrayed thermal cameras are electronically steerable over the half hemisphere. The anti-drone system further includes lasers to interfere with the imaging sensors of the drones. Although the descriptions herein describe defeating drones, the anti-drone system may be used to impair or damage any target(s) having electronic/optical sensors and systems. Further, the half hemisphere field of regard or field coverage are described merely as examples as the system is easily extensible or scalable to cover the entire 4π steradians.

After reading the below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

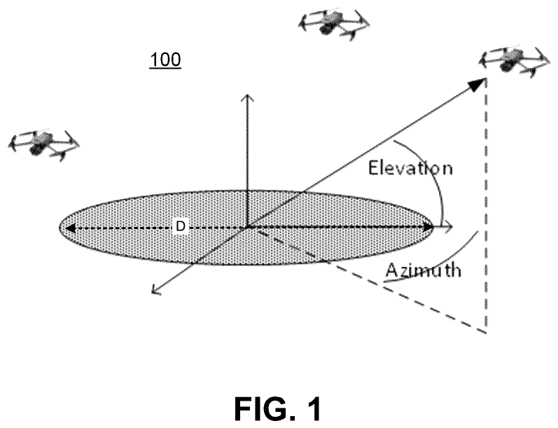

FIG. 1 is an example illustration of a multimodal anti-drone system 100 where the protected area geometry shown covers a circle of diameter D (e.g., diameter of 1 km). The scaling of the protected area can be easily flowed down to the constituent elements in terms of both detection range as well as force projection requirements. The detection and tracking aspects of the system are provided primarily by thermal imaging cameras which are arrayed to cover one half of one hemisphere (“half hemisphere”).

Other sensor modalities may be used to augment these capabilities. The force projection function is provided by one or more laser sources that are coupled to a telescope with optimal aperture design and a fast gimbal system to articulate the response across the half hemisphere. These lasers are chosen to provide high power at relatively low cost (e.g., CO₂ laser and fiber laser) and wavelengths that overlap with common camera parameters (e.g., visible, near-infrared (NIR), long-wave infrared (LWIR)) consistent with lightweight drone platforms. An S-band phased array provides an additional degree of freedom to project sufficient radio frequency (RF) power to strongly disrupt communication subsystems commonly found in drones. None of the force projection techniques are meant to physically destroy the drone but to disable its autonomous or remotely accessed control.

In one implementation, the system includes: (1) an array of thermal cameras to cover the 360° azimuthal and 90° elevation of field of regard; (2) an S-band (or similar electromagnetic coverage consistent with high power source generation and ability to interfere with drone communication links) phased array with sufficient power to disable the drone and electronically steerable over the same half hemisphere of field of regard; and (3) laser(s) designed to interfere with or damage the drone's imaging sensors. Each element of the system is described below in detail.

Regarding the array of thermal cameras, existing persistent surveillance systems rely on a mechanically steered platform to achieve a wide field of regard (FOR). However, the instantaneously available field of view (FOV) is limited to a be a small subset of FOR, which makes it difficult to track a swarm of drones. To be persistent and rapidly available, the system must provide pixel coverage across the entire FOR. This is achieved by tiling the FOR with thermal cameras having a given camera FOV (cFOV).

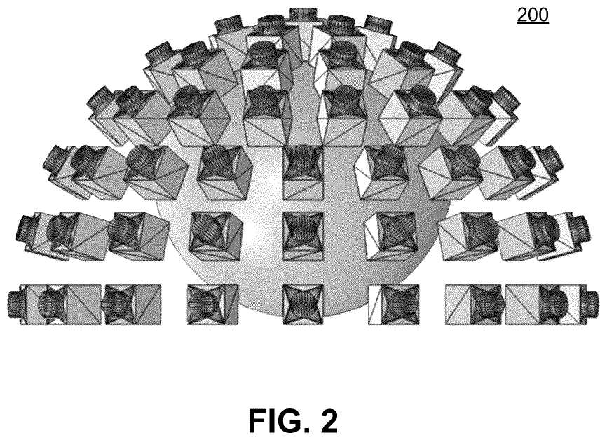

FIG. 2 illustrates an example half hemisphere tessellation 200 of cameras in accordance with one implementation of the present disclosure. For reference, the sphere inside the array is the size of a soccer ball.

In the illustrated implementation of FIG. 2, each camera has a cFOV that is smaller than the system FOR. For example, if the cFOV is 20° (horizontal) by 15° (vertical), 43 such cameras would provide slightly overlapping coverage across the half hemisphere. Thus, if each camera has a 30 Hz frame update rate, the entire FOR has the same update rate, much faster than typical, scanned systems where seconds of response time must be accommodated. Further, if each camera supports a VGA format (i.e., 640×480 pixels), then the detection range of the system may be calculated. That is, the instantaneous field of view (IFOV) of the camera is equal to the cFOV divided by number of pixels along the same dimension. In the VGA case, the IFOV is computed to be 0.03125° (20/640=0.03125). If the target to be detected has a lateral size of 1 m, the maximum range for detection is calculated to be 1.8 Km. Using the same 4:3 aspect ratio and the same cFOV, higher pixel counts can be used to realize longer ranges for detection. For example, increasing the number of pixels in each dimension by 3×(e.g., scaling from VGA to WUXGA which is not quite 4:3 but close, at 1920×1200), increases the range to 3×1.8 Km=5.4 Km. In reviewing the cost of cameras, a typical price for a VGA thermal camera is $3,000. Thus, 43 such cameras total to $129,000. Increasing the capabilities to the full high-definition (FHD) category (e.g., WUXGA), where the per camera cost typically is about $20,000, the system becomes prohibitively expensive.

In one implementation, an uncooled microbolometer built on glass using flat panel display fabrication processes, which powers the camera, is used to lower the cost. For example, using the uncooled microbolometer places the price point of an FHD class camera in the $1,000 to $2,000 range (comparable cameras of this resolution are currently selling for $30,000 to $60,000 range), and makes a high-performance, full-scale version of the system entirely feasible.

In one implementation, Table 1 below summarizes the scaled versions of the half hemisphere surveillance system for a range of underlying sensor array formats to detect an object of 1 m in diameter, for example.

TABLE 1

| | VGA | SVGA | XGA | SXGA | UXGA | WUXGA |
|---|---|---|---|---|---|---|
| Pixel Format | 640 × 480 | 800 × 600 | 1024 × 768 | 1400 × 1050 | 1600 × 1200 | 1920 × 1200 |
| Aspect Ratio | 4:3 | 4:3 | 4:3 | 4:3 | 4:3 | 8:5 |
| cHFOV [deg] | 20 | 20 | 20 | 20 | 20 | 20 |
| cVFOV [deg] | 15 | 15 | 15 | 15 | 15 | 15 |
| IFOV [deg] | 0.03125 | 0.02500 | 0.01953 | 0.01429 | 0.01250 | 0.01042 |
| Range [m] | 1833.46 | 2291.83 | 2933.54 | 4010.70 | 4583.66 | 5500.39 |

In the above implementation, each thermal camera is outfitted with an artificial intelligence (AI) processor that can implement object detection algorithms at the camera level to tag each video stream with metadata on the location and label for each object detected within cFOV. This provides low latency access to drive the defeat mechanism or apply extra attention to scrutinize the level of confidence in the detection/classification.

In one implementation, an AI processor with at least two tera operations per second (TOPS), for example, to implement a convolutional neural net (CNN) system that can yield object recognition and tracking functions in real time. Handling such functions at the edge (in each constituent camera) reduces the likelihood of video data bottlenecks from having to fuse the massive number of pixels.

In one implementation, a visible camera array may be implemented following the same principles already outlined for the thermal camera. Alternatively, a zoom-capable camera with rapidly articulating gimbal system may be used to zoom in regions of interest to help scrutinize the degree of confidence in the object classification produced by the thermal camera alone. Moreover, the coordination between the visible and thermal suites can produce highly accurate stereo derived range information (i.e., known geometry of the two sensor suites).

In one implementation, the complementary visible spectrum cameras are arrayed within the same constellation to realize a bi-spectral observation system that is completely solid state. The fields of view of the constituent thermal and visible cameras may be designed to be the same, resulting in the same number of thermal and visible cameras. Alternatively, the field of view of the visible camera may be chosen to be larger than that of the thermal camera, which would require a sparser array of visible cameras across the field of regard.

Regarding the S-band high power microwave drone defeat system, an optimum aperture exists for projecting electromagnetic power from a source, given the bounded nature of the protection problem (i.e., the limited range of power projection that is necessary, for example, the fence line perimeter). Although plane wave concepts are typically used to explain propagation, it is more proper to use bounded waves such as gaussian beams. The power per unit area of a directed gaussian beam is expressed by the equation:

$$I ( r , z ) = \frac{P}{\frac{π}{2} {W ( z )}^{2}} exp [ - 2 \frac{{r}^{2}}{{W ( z )}^{2}} ] , \qquad [ 1 ]$$

where P is the total power emitted by the source, W(z) is the beam waist (radius) as a function of the propagation distance z and r is the radial coordinate. The waist at the origin W₀=W(0) is the launched condition and roughly represents the transmit aperture of the system.

$$W ( z ) = {W}_{0} \sqrt{1 + {( \frac{z}{{z}_{R}} )}^{2}} = {W}_{0} \sqrt{1 + {( \frac{z λ}{π {W}_{0}^{2}} )}^{2}} . \qquad [ 2 ]$$

If a maximum distance over which power must be delivered (zₘₐₓ) is set, then the optimum value of W₀ may be determined that will deliver the maximum value for I(0, zₘₐₓ). The optimum value for the beam waist is

$${W}_{0} = \sqrt{\frac{{z}_{max} λ}{π}} . \qquad [ 3 ]$$

And the resulting I(0, z) is given by

$$I ( 0 , z ) = \frac{2 P}{{z}_{max} λ ( 1 + {( \frac{Z}{{z}_{max}} )}^{2} )} . \qquad [ 4 ]$$

This result applies to all electromagnetic radiation that can be launched as a gaussian beam. The so-called Bessel beam which is in a class of waves with minimal diffraction may result in slightly better performance at the cost of complexity. The actual gain is minimal since the Bessel beam has infinite transverse extent and truncation leads to diffractive loss.

Most inexpensive UAS systems operate communications over s-band, specifically near wifi frequencies (2.4 GHZ). An efficient method to generate high power (e.g., the magnetron) is especially suited for this band with 1-2 KW magnetrons powering most household microwave ovens. Water-cooled systems as large as 10 MW can be bought from specialty suppliers, while a 100 KW system may be purchased for $0.5/watt (i.e., $50,000 for the 100 KW system). At 2.4 GHz, the optimum waist is 12.6 m. To compare the power delivered to a target at zₘₐₓ=1 Km, the gaussian beam intensity value I(0, zₘₐₓ) is evaluated for the optimum beam waist and one that is much smaller, W₀=1 m.

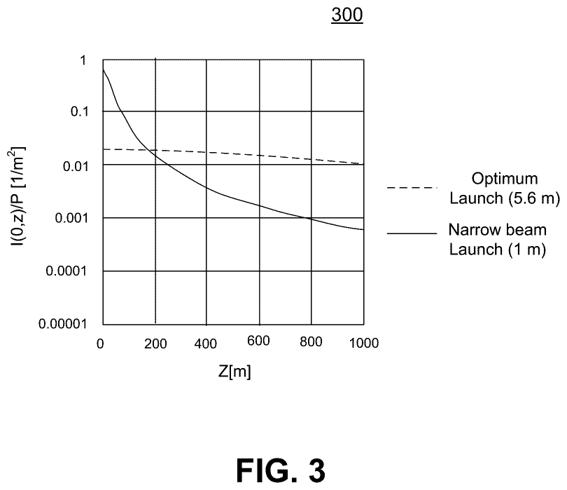

FIG. 3 illustrates the comparative plot 300 (comparison between W₀=1 m launch and optimum W₀=5.6 m launch) in accordance with one implementation of the present disclosure. The plot shows that the narrower beam begins with a much higher intensity value but quickly broadens due to diffraction.

In the illustrated implementation of FIG. 3, beginning with the total source power P, the intensity at beam center delivered to the target at zₘₐₓ is

$$I ( 0 , {z}_{max} ) = \frac{P}{{z}_{max} λ} . \qquad [ 5 ]$$

For P=100 KW, equation [5] evaluates the intensity delivered to be 1 KW/m² which is equivalent to an electric field strength of 870 V/m. Such levels of intensity may cause damage to sensitive communications equipment on drones and may substantially disrupt communications on most UAS platforms.

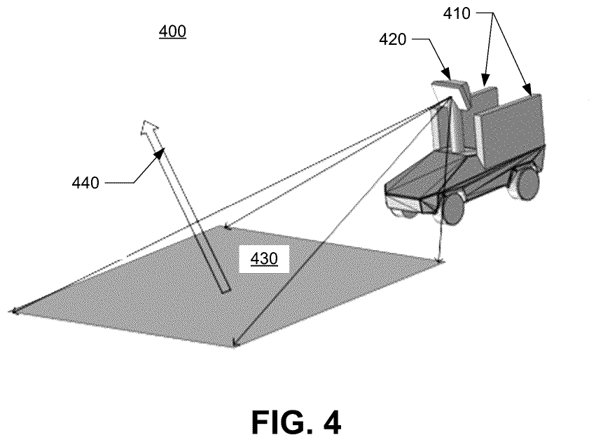

FIG. 4 illustrates an example deployable system 400 in accordance with one implementation of the present disclosure. Illustrated implementation of FIG. 4 shows placements of two half-hemisphere thermal imaging arrays 410 on a vehicle as well as a mast mounted magnetron 420 with horn radiator launcher linearly polarized to match the input antennas polarization, orthogonal to the output antennas on 430, illuminating a phased array reflective aperture 430. In one implementation, the sides of the vehicle support the half-hemisphere coverage thermal camera array and can also hold other sensor suites. In one implementation, the aperture 430 is square or circular in profile and generates electronically-steered RF beam 440, as shown. In another implementation, the aperture 430 may be configured as an aperture that is oriented more vertically with respect to the ground and may also be implemented as a transmit array in which case the magnetron source 420 would launch a beam that goes through the transmit array.

In one implementation, the phased array is an assembly of patch, slot, dipole or other low-profile antennas placed at a pitch of approximately μ/2 across the aperture, where λ is the wavelength of the microwave radiation to be projected. Specifically, if a frequency of 2.4 GHz is used, then λ=12.5 cm. In the case of a reflective array, the input and output antennas are on the same side but orthogonally polarized. The configuration of the orthogonal antennas has at least two configurations. In the case of a transmit array, there is an input side and an output side set of antennas coupled together through vias in a suitable printed-circuit board (PCB). In both cases, the output antenna (with the reflective array, the output and input antennas are the same) is loaded with a varactor or a parallel array of transmission line lengths with a switch matrix to impart a phase delay on either the reflected or transmitted energy. All the elements in the array are identical and can be designed and implemented as identically manufactured PCB with either switched transmission lines or varactors. Since only a single beam is needed at any given time, the phase distribution needed for the two dimensions is separable and only 2N control voltages are needed, for an N×N element array.

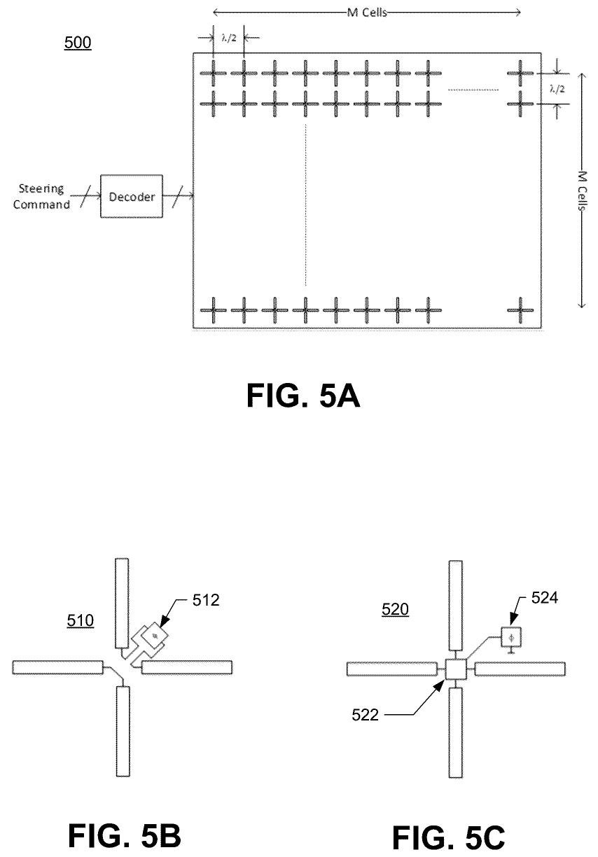

FIG. 5A shows an example realization 500 for a steerable reflector array in accordance with one implementation of the present disclosure. In one implementation, the source illumination (as illustrated in FIG. 4) is polarized to align with one of the two crossed dipoles (as illustrated in FIG. 5B), which is connected through a phase shifter to the orthogonal dipole antenna which re-radiates the energy with a prescribed phase shift.

FIGS. 5B and 5C illustrate an individual antenna element configuration, where the two antenna elements are coupled through a phase modulator.

FIG. 5B shows orthogonally polarized input and output antennas and a transmissive phase modulator 512. In one implementation, the cross-polarized antenna configuration uses the variable phase shifter where the receiving antenna is coupled to the transmitting antenna through the phase modulator 512.

FIG. 5C shows the two antenna outputs combined with a power combiner 522 having 4 antenna ports connected to it with the combined output terminated by a reflective phase modulator.

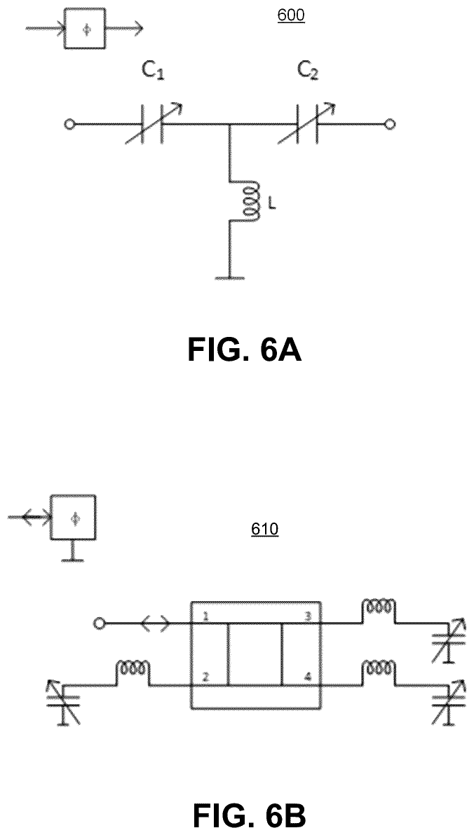

FIG. 6A shows varactors 600 used to modulate the microwave signal with a desired phase shift that is monotonically varying with the bias voltage across the variable capacitance diodes C1 and C2 (transmissive phase modulator configuration). Thus, in one implementation shown in FIG. 6A, diode or MEMS capacitive implementations of varactors are used to provide low-cost phase shifting at the single frequency operation of the system.

FIG. 6B shows an alternative implementation using reflective geometries with hybrid couplers to provide low-cost phase shifting at the single frequency operation of the system. The illustrated implementation of FIG. 6B shows a reflectarray configuration 610, where each single antenna element (or the combined output of two cross polarized antennas) is connected to a 90-hybrid circuit (i.e., a circuit that uses a 90° hybrid coupler to split or combine signals) whose 4 ports are connected as shown. The hybrid coupler connects the received input signal and routes the input signal to the opposite ports 3, 4. The ports 3, 4 reflect and combine the signal into the isolated port 2 on resonance. The input signal is reflected back toward ports 3, 4 and back into port 1, which is seen as a reflected signal with appropriate phase accrued through the LC loads terminating ports 2, 3, and 4. Since the function of the array is to produce one agile beam, the distribution of phase across the array is linear and the decoding necessary to convert a steering command is a straightforward mapping. The λ/2 horizontal and vertical spacing of the antenna elements (as shown in FIG. 5A) ensures a single beam. As a numerical example, assuming the frequency of the source is 2.4 GHz with a wavelength of about 125 mm, for an array of 10,000 elements that spans an area of 6.25×6.25 m², the power in each antenna element as illuminated by the 100 KW source is 10 W.

Regarding the laser drone defeat system, most imaging and ranging sensors on drones rely on either visible-NIR or LWIR electromagnetic bands. To damage or disable such sensitive sensors, high power lasers that oscillate near 1 μm and 10 μm are needed. Accordingly, CO₂ lasers, fiber and YAG lasers are among the least expensive laser systems in terms of $/watt and are appropriate for use in the system.

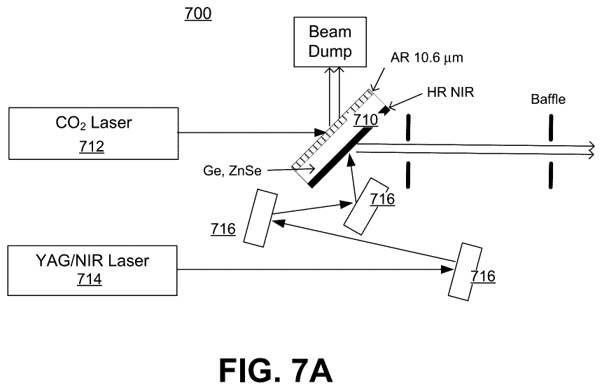

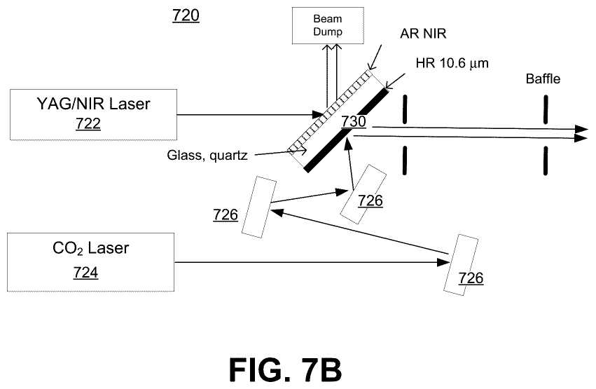

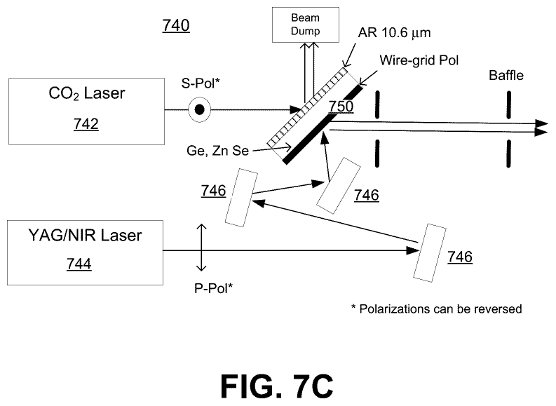

FIGS. 7A through 7C illustrate different implementations to combine two or more laser sources onto a common optical axis in accordance with one implementation of the present disclosure. Such a collinear combination of laser sources is important since there should be one beam pointing device to allow for agile targeting. The cost of telescope optics is also a consideration. The telescope must use reflective optics since a very disparate set of wavelengths need to be accommodated. In the illustrated implementations of FIGS. 7A through 7C, the laser beams are combined prior to beam expansion to feed the telescope or the beam expanders can be placed prior to beam combining to reduce the possibility of laser damage.

FIG. 7A illustrates a laser combiner 700 in accordance with one implementation of the present disclosure. In the illustrated implementation of FIG. 7A, the laser combiner 700 includes a dichroic beamsplitter 710, a CO₂ laser 712, an yttrium aluminum garnet (YAG) or fiber near infrared (NIR) laser (YAG/NIR laser) 714, and a plurality of mirrors 716. Although the illustrated implementation of FIG. 7A shows 3 mirrors 716, the beam from the YAG/NIR laser 714 can be aligned with either 1, 2, or 3 mirrors 716. However, the three-mirror system makes it easier to co-align the beam to the CO₂ laser beam.

In one implementation, the dichroic beamsplitter 710 is made of germanium (Ge), Silicon (Si), Zinc Selenide (ZnSe), Zinc Sulfide (ZnS) substrate, or any other material that transmits 10.6 μm radiation, and that passes power from the CO₂ laser with a high reflectance (HR) coating to reflect NIR wavelengths with high efficiency while passing the LWIR CO₂ laser power with low attenuation. In other implementations, other combination of lasers that do not damage thermal and visible imagers may be used.

FIG. 7B illustrates a laser combiner 720 in accordance with another implementation of the present disclosure. In the illustrated implementation of FIG. 7B, the laser combiner 720 includes a dichroic beamsplitter 730, a YAG/NIR laser 722, a CO₂ laser 724, and a plurality of mirrors 726. Although the illustrated implementation of FIG. 7B shows 3 mirrors 726, the beam from the CO₂ laser 724 can be aligned with either 1, 2, or 3 mirrors 726. However, the three-mirror system makes it easier to co-align the beam to the YAG/NIR laser beam.

In one implementation, the dichroic beamsplitter 730 uses an NIR passing substrate (e.g., glass or quartz) to pass the YAG or fiber laser power and uses a high reflectance coating to reflect the 10.6 μm CO₂ laser power. In other implementations, other combinations of lasers may be used including visible lasers as well as NIR lasers (e.g., doubled YAG, Accessible Radiation (AR) laser, Titanium-Sapphire laser, excimer laser, etc.).

FIG. 7C illustrates a laser combiner 740 in accordance with another implementation of the present disclosure. In the illustrated implementation of FIG. 7C, the laser combiner 740 includes a wire-grid-type beamsplitter 750, a CO₂ laser 742, a YAG/NIR laser 744, and a plurality of mirrors 746. Although the illustrated implementation of FIG. 7C shows 3 mirrors 746, the beam from the YAG/NIR laser 744 can be aligned with either 1, 2, or 3 mirrors 746. However, the three-mirror system makes it easier to co-align the beam to the CO₂ laser beam.

In one implementation, the CO₂ laser 742 outputs an S-polarized light (S-pol), while the YAG/NIR laser 744 outputs a P-polarized light (P-pol). In this implementation, for example, the beamsplitter (or polarizer) 750 uses the polarization diversity to combine the two laser outputs, where the directions of the wires or nano-wires are oriented in such a way to transmit the S-polarized beam from the CO₂ laser 742 transmits through the polarizer 750 while the P-polarized beam from the YAG/NIR laser 744 reflects from the polarizer 750.

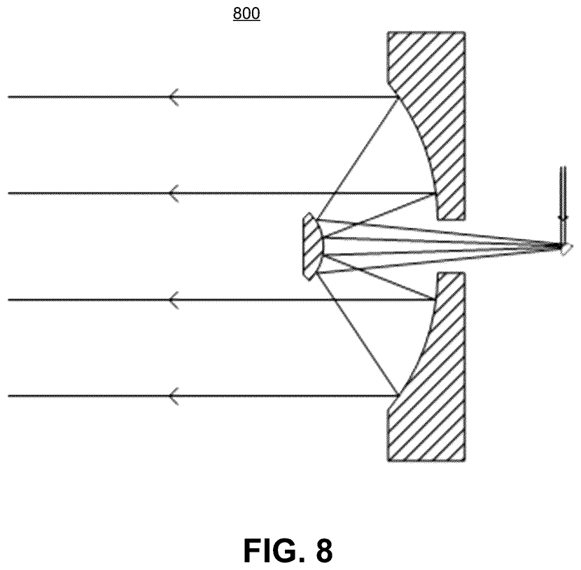

With the multiple laser wavelengths aligned onto a common axis, the composite beam can be delivered to a two-mirror telescope shown in FIG. 8. Other arrangements of multi-mirror telescopes may be used, along with non-obstructing off-axis designs.

In one implementation, a system includes: a plurality of arrayed thermal cameras to provide simultaneous viewing across a half hemisphere of field of regard, wherein each of the plurality of arrayed thermal cameras includes a camera field of view that is overlapping with neighboring cameras.

In one implementation, outputs of the plurality of arrayed thermal cameras are electronically combined to provide a full coverage over the half hemisphere of field of regard. In one implementation, the system further includes: a master controller to compute position of at least one drone including at least range, azimuth, and elevation for targeting. In one implementation, each camera of the plurality of arrayed thermal cameras includes: an artificial intelligence (AI) processor to provide object recognition and tracking functions for use by the master controller. In one implementation, the AI processor is configured to provide at least two tera operations per second (TOPS) to implement a convolutional neural net (CNN) system that yields the object recognition and tracking functions in real time. In one implementation, the half hemisphere of field of regard of the plurality of arrayed thermal cameras is achieved by tiling the camera field of view of each thermal camera. In one implementation, each thermal camera is powered by an uncooled microbolometer. In one implementation, the uncooled microbolometer is built on glass using flat panel display fabrication processes.

In another implementation, a drone defeat system to disable a drone is disclosed. The drone defeat system includes: a plurality of steerable laser sources to impair or damage sensors of the drone; a laser combiner to combine outputs of the plurality of steerable laser sources into a combined output that is steerable; and an electronically steerable high power microwave source to impair or damage communication systems of the drone.

In one implementation, the system further includes a gimbal system to steer the combined output toward the drone. In one implementation, the gimbal system includes a steerable mirror component to reflect the combined output. In one implementation, the laser combiner includes: a dichroic beamsplitter; a CO₂ laser; a near infrared (NIR) laser; and a plurality of mirrors. In one implementation, the NIR laser includes an yttrium aluminum garnet (YAG) laser. In one implementation, the dichroic beamsplitter is made of a material that transmits 10.6 μm radiation. In one implementation, the dichroic beamsplitter is made of one of germanium (Ge), Silicon (Si), Zinc Selenide (ZnSe), or Zinc Sulfide (ZnS) substrate. In one implementation, the laser combiner includes: a dichroic beamsplitter; an yttrium aluminum garnet/near infrared (YAG/NIR) laser; a CO₂ laser; and a plurality of mirrors. In one implementation, the laser combiner includes: a wire-grid-type beamsplitter; a CO₂ laser to output an S-polarized light; an yttrium aluminum garnet/near infrared (YAG/NIR) laser to output a P-polarized light; and a plurality of mirrors. In one implementation, the laser combiner includes: a wire-grid-type beamsplitter; a CO₂ laser to output a P-polarized light; an yttrium aluminum garnet/near infrared (YAG/NIR) laser to output an S-polarized light; and a plurality of mirrors. In one implementation, the electronically steerable high power microwave source is a magnetron. In one implementation, the drone defeat system further includes a reflective or transmissive phased array of planar antennas configured to receive and reflect outputs of the electronically steerable high power microwave source and direct the reflected outputs toward the drone. In one implementation, the reflective or transmissive phased array of planar antennas is an assembly of low-profile antennas including patch, slot, or dipole antennas, using a phase shifting device at each antenna to impart a desired phase distribution to rapidly point the reflected outputs toward the drone.

In yet another implementation, a system of thermal cameras is disclosed. The thermal camera system includes: a set of thermal cameras each assigned to cover a certain field of view; a mechanical truss to hold the thermal cameras in alignment to tesselate the field of regard; and an edge AI processor integrated into each thermal camera.

In yet another implementation, a drone defeat system which works with the thermal camera system to impair the sensors and communication systems of a target drone is disclosed. The drone defeat system includes: a laser system that projects power in the visible-NIR spectrum (400-1000 nm) and LWIR spectrum (8-14 μm) to impair the dominant sensors used to guide drones autonomously and a microwave power projection system to impair drone communication electronics.

Those skilled in the art will recognize that the implementations described herein are representative, and deviations from the explicitly disclosed implementations are within the scope of the disclosure.

Although the disclosed implementations have been fully described with reference to the accompanying drawings, it is to be noted that various changes and modifications will become apparent to those skilled in the art. Such changes and modifications are to be understood as being included within the scope of the disclosed implementations as defined by the appended claims.

All features of each of the above-discussed examples are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A system comprising:
a plurality of arrayed thermal cameras to provide simultaneous viewing across a half hemisphere of field of regard,
wherein each of the plurality of arrayed thermal cameras includes a camera field of view that is overlapping with neighboring cameras.

2. The system of claim 1, wherein outputs of the plurality of arrayed thermal cameras are electronically combined to provide a full coverage over the half hemisphere of field of regard.

3. The system of claim 1, further comprising:
a master controller to compute position of at least one drone including at least range, azimuth, and elevation for targeting.

4. The system of claim 3, wherein each camera of the plurality of arrayed thermal cameras includes:
an artificial intelligence (AI) processor to provide object recognition and tracking functions for use by the master controller.

5. The system of claim 4, wherein the AI processor is configured to provide at least two tera operations per second (TOPS) to implement a convolutional neural net (CNN) system that yields the object recognition and tracking functions in real time.

6. The system of claim 1, wherein the half hemisphere of field of regard of the plurality of arrayed thermal cameras is achieved by tiling the camera field of view of each thermal camera.

7. The system of claim 1, wherein each thermal camera is powered by an uncooled microbolometer.

8. The system of claim 7, wherein the uncooled microbolometer is built on glass using flat panel display fabrication processes.

9. A drone defeat system to disable a drone, the drone defeat system comprising:
a plurality of steerable laser sources to impair or damage sensors of the drone;
a laser combiner to combine outputs of the plurality of steerable laser sources into a combined output that is steerable; and
an electronically steerable high power microwave source to impair or damage communication systems of the drone.

10. The drone defeat system of claim 9, further comprising:
a gimbal system to steer the combined output toward the drone.

11. The drone defeat system of claim 10, wherein the gimbal system comprises a steerable mirror component to reflect the combined output.

12. The drone defeat system of claim 9, wherein the laser combiner comprises:
a dichroic beamsplitter;
a CO₂ laser;
a near infrared (NIR) laser; and
a plurality of mirrors.

13. The drone defeat system of claim 12, wherein the NIR laser includes an yttrium aluminum garnet (YAG) laser.

14. The drone defeat system of claim 12, wherein the dichroic beamsplitter is made of a material that transmits 10.6 μm radiation.

15. The drone defeat system of claim 12, wherein the dichroic beamsplitter is made of one of germanium (Ge), Silicon (Si), Zinc Selenide (ZnSe), or Zinc Sulfide (ZnS) substrate.

16. The drone defeat system of claim 9, wherein the laser combiner comprises:
a dichroic beamsplitter;
an yttrium aluminum garnet/near infrared (YAG/NIR) laser;
a CO₂ laser; and
a plurality of mirrors.

17. The drone defeat system of claim 9, wherein the laser combiner comprises:
a wire-grid-type beamsplitter;
a CO₂ laser to output an S-polarized light;
an yttrium aluminum garnet/near infrared (YAG/NIR) laser to output a P-polarized light; and
a plurality of mirrors.

18. The drone defeat system of claim 9, wherein the electronically steerable high power microwave source is a magnetron.

19. The drone defeat system of claim 9, further comprising:
a reflective or transmissive phased array of planar antennas configured to receive and reflect outputs of the electronically steerable high power microwave source and direct the reflected outputs toward the drone.

20. The drone defeat system of claim 19, wherein the reflective or transmissive phased array of planar antennas is an assembly of low-profile antennas including patch, slot, or dipole antennas, using a phase shifting device at each antenna to impart a desired phase distribution to rapidly point the reflected outputs toward the drone.
